(19) United States
(12) Patent Application Publication
(10) Pub. No.: US 2016/0010249 A1
(43) Pub. Date: Jan. 14, 2016

(54) CORE FOR INSULATION MATERIAL, MANUFACTURING METHOD THEREFOR, AND SLIM INSULATING MATERIAL USING SAME

(71) Applicant: AMOGREENTECH CO., LTD., Gimpo-si Gyeonggi-do (KR)

(72) Inventor: Seung Jae HWANG, Incheon (KR)

(73) Assignee: AMOGREENTECH CO., LTD., Gimpo-si Gyeonggi-do (KR)

(21) Appl. No.: 14/771,940

(22) PCT Filed: Feb. 28, 2014
(86) PCT No.: PCT/KR2014/001692

§ 371 Date: Sep. 1, 2015

(30) Foreign Application Priority Data
Mar. 7, 2013 (KR) 10-2013-0024668

(51) Int. Cl. D04H 1/4382; B32B 3/28; D01D 5/00; B32B 5/26; D04H 1/43; D04H 1/4318; B32B 5/02

(52) U.S. Cl. CPC D04H 1/4382; D04H 1/4318; B32B 3/28; B32B 5/022; B32B 5/26; D04H 1/43; D01D 5/003; B32B 2307/306; B32B 2307/54; B32B 2307/304

(57) ABSTRACT

Provided are an insulator core, a method of manufacturing the same, and a slim insulator using the same, in which the insulator core is provided with a plurality of fine pores of a three-dimensional structure capable of trapping air by using, as a core member, a multi-layered laminate of nanowebs made of nanofibers that are obtained by electrospinning a polymer material with a low thermal conductivity, and has excellent heat insulating performance even with a thin film. Accordingly, the insulator core includes porous nanowebs which are made of a polymer with a low thermal conductivity and integrated by nanofibers having a diameter of 3 μm or less to be spun, thus having a three-dimensional fine-pore structure.

### TECHNICAL FIELD

The present invention relates to a slim type insulator, and more particularly to an insulator core, a method of manufacturing the insulator core, and a slim type insulator using the insulator core, in which the insulator core is provided with a plurality of fine pores of a three-dimensional structure capable of trapping air by using, as a core member, a multi-layered laminate of nanowebs made of nanofibers that are obtained by electrospinning a polymer material with a low thermal conductivity, and has excellent heat insulating performance even with a thin film.

### BACKGROUND ART

In the Republic of Korea, insulators include organic insulators such as expanded polystyrene, expanded polyurethane, extruded expanded polystyrene, or polyethylene, occupied at a ratio of 65%, and inorganic insulators such as glass wool or mineral wool, occupied at a ratio of 35%. The latest insulators such as VIPs (Vacuum Insulating Panels) or aerogels have been used in some buildings by mainly large construction companies, but have not yet been popularized.

The thermal conductivities of various insulators are summarized in following Table 1.

TABLE 1

| | Thermal conductivity | |
|---|---|---|
| Kinds | (unit: mW/mK) | Remarks |
| Mineral wool | 30-40 | |
| Expanded polystyrene (EPS) | 30-40 | |
| foam | | |
| Extruded polystyrene (XPS) | 30-40 | |
| foam | | |
| Cellulose | 40-50 | |
| Cork | 40-50 | |
| Polyurethane | 20-30 | |
| VIPs | 3-4 | |
| GFPs | 40 | |
| Aerogels | 13-14 | |

Here, VIPs (Vacuum Insulating Panels) have a structure that a core member such as fumed silica is wrapped by a shell member with the interior of the vacuum, and GFPs (Green Fluorescent Proteins) have a structure employing an inert gas such as Ar, Kr, or Xe having a lower thermal conductivity than the air instead of the vacuum in the structure of VIPs.

As described above, the recent popular insulators are the VIPs and aerogels. The thermal conductivity of the VIPs is the lowest as 4 mW/mK, but when the shell of the insulator is damaged due to penetration of moisture and air, the thermal conductivity of the VIPs can be increased to at least 20 mW/mK. As a result, the VIPs cannot be cut and used in the construction field. The aero gels have the thermal conductivity of 13 mW/mK, do not increase with the passage of time, take low impact properties to the drilling, and are applicable to the construction site more frequently than the VIPs. The VIPs and aerogels are still expensive. However, the VIPs are expected to greatly expand the living area in comparison with the conventional insulators to thus increase economic effects.

The VIP includes: a core member; a getter member to adsorb moisture or gas in the core member; and a shell member surrounding the core member, in which the inside of the shell member is formed in the state of a vacuum or a reduced pressure.

In general, the VIP including a getter member is prepared in a manner that a pouch-type getter member envelope is inserted in an inner core member, to then be surrounded with a shell member, or a getter member is put on the surface of a core member, to then be surrounded with a shell member.

In the conventional method as described above, when the core member and the getter member are sealed with the shell member, and then air is exhaled from the inner portion sealed by the shell member, the core member and the shell member are contracted, thereby raising a phenomenon of protruding a portion where the getter member is inserted.

Such a protruding part of the getter member causes a variation in thickness of the outer surface of the vacuum insulator, and therefore, when applying the VIP for building, home appliance or the like, the surface leveling property and the like is deteriorated.

In order to solve this problem, in recent years, a method of producing a VIP is used in which after processing grooves on the surface of the core member, a getter member is placed in the grooves, and the whole core member is coated with a shell member.

However, even in the case of this method, a problem of causing the protruding portion cannot be completely solved. In addition, a problem of degrading thermal performance in a cut portion of the core member through the processing of the grooves.

In addition, the shell member of the VIP is formed so that various layers of films are laminated, in which each of the films includes a film of performing three functions. That is, the VIP includes: a protection layer that primarily protects the VIP from an external impact; a barrier layer that maintains the degree of vacuum inside and that blocks external gas and water vapor; and a sealing layer with which the shell member is in close contact to thereby maintain a panel-like configuration.

A VIP has been proposed in Korean Patent Application Publication No. 10-2011-77859. In Korean Patent Application Publication No. 10-2011-77859, the VIP includes a core portion including a core member; and a shell member coating the core member, in which the core portion is formed under the circumstance of a reduced pressure, and the shell member comprises at least one nonwoven fabric layer. In this case, the core member of the VIP employs at least one of glass fiber, polyurethane, polyester, polypropylene and polyethylene.

A core of a VIP has been proposed in Korean Patent Application Publication No. 10-2011-15326, in which a core is located in the inside of a shell of the VIP, and the core is made by thermally fusing synthetic resin fibers and bonding the thermally fused synthetic resin fibers.

A VIP has been proposed in Korean Patent Application Publication No. 10-2011-15325, which includes: a core which has a predetermined shape in which a reduced pressure space is formed; and a gas barrier layer which is formed by coating a predetermined material on the surface of the core so as to have gas barrier property.

A VIP has been proposed in Korean Patent Application Publication No. 10-2011-15324, which includes: a shell which has gas barrier property and is formed of an inner space having a predetermined reduced pressure; and a core which has a predetermined shape in which an empty space is formed, and disposed in the inside of the shell to thus support the shell.

A VIP has been proposed in Korean Patent Application Publication No. 10-2011-133451, which includes: aerogel sheets having aerogels on the surface of or inside of a natural fiber sheet; a filler that is formed by laminating a multiplicity of the aerogel sheets; and a shell member that is formed by coating a resin on the inner and outer surfaces of an aluminum foil that forms an internal space so as to surround the filler in which the internal space is formed of a vacuum.

A VIP has been proposed in Korean Patent Application Publication No. 10-2013-15183, which includes an outer coating material that coats a core member and has gas-barrier property. In the VIP that is sealed by reducing pressure in the inside of the outer coating material, the core is made of a fiber aggregate, and the fiber includes a hollow portion therein.

In this case, the core member is made of a glass fiber or a glass wool. The outer diameter of the glass fiber is formed of 1 to 10 μm, and the inner diameter of the hollow portion is formed of several nanometers to 5 μm or less in size. The core member is made of a board-shaped core member by the method of any one of a hot-press method, a needling method, and a wet method using a mixture of water and a binder.

When a glass fiber aggregate is decompressed by a hot-press method to then be formed into a board-shaped core member, the core member proposed in Korean Patent Application Publication No. 10-2013-15183 is heated at a temperature where the cross-sectional shape of the glass fiber is not much changed in the softening state (that is, at a temperature where the glass fiber starts to be transformed a little by its own gravitational weight, or at a temperature where the glass fiber is possible to be transformed by its own gravitational weight from the vertical direction of a press) to then be pressed. However, since the flexibility of the glass fiber is not high, pores between the glass fibers within the glass fiber aggregate become large.

Thus, the pore size in the inside of the glass fiber aggregate does not have a size suitable for trapping air, and thus the heat insulating effect is low. In addition, the glass fiber of a hollow structure has the complicated and difficult manufacturing process problem.

As described above, the conventional VIP employs a core made of at least one of a glass fiber, polyurethane, polyester, polypropylene, polyethylene and fumed silica, an aerogel sheet of a lamination structure, and the like, in the inside of the shell member, but thermal conductivity is high, material costs are high, or the manufacturing process is difficult.

In addition, since a method of increasing the thickness to increase the thermal insulation performance reverses a slimming trend, it is required to develop a core for a VIP having excellent insulating performance as well as a slimming type.

Moreover, a general VIP is not so easily be applied in the building construction, and in the case of fixing the general VIP by using a nail, the vacuum state is broken, and thus the insulation performance may largely decrease.

### DISCLOSURE

### Technical Problem

To solve the above problems or defects, it is an object of the present invention to provide an insulator core, which is provided with a plurality of fine pores of a three-dimensional structure capable of trapping air by using, as a core member, a multi-layered laminate of nanowebs made of nanofibers that are obtained by electrospinning a polymer material with a low thermal conductivity, and has excellent heat insulating performance even in the case that the inside of a shell member is not a vacuum, a method of manufacturing the insulator core, and a slim type insulator using the insulator core.

It is another object of the present invention to provide an insulator core, which is provided with a plurality of fine pores of a three-dimensional structure capable of trapping air by using, as a core member, a multi-layered laminate of nanowebs made of nanofibers that are obtained by electrospinning a polymer material with a low thermal conductivity, and has excellent heat insulating performance even with a thin film, a method of manufacturing the insulator core, and a slim type insulator using the insulator core.

It is still another object of the present invention to provide an insulator core which has excellent heat insulating performance by using, as a core member, a multi-layered laminate of nanowebs made of nanofibers that are obtained by electrospinning at least one polymer material with a low thermal conductivity, and even with a thin film, and a method of manufacturing the insulator core.

It is yet another object of the present invention an insulator core which has excellent heat insulating performance by using, as a core member, a multi-layered laminate of nanowebs made of nanofibers that are obtained by electrospinning a polymer material with a low thermal conductivity and an excellent heat resistance alone, or a mixture polymer that is obtained by mixing a polymer with a low thermal conductivity and a polymer with an excellent heat resistance at a predetermined mixture ratio, and a method of manufacturing the insulator core.

It is still yet another object of the present invention an insulator core which can improve the tensile strength of the insulator core required when laminating a core member, to thereby improve productivity of the insulator core, by using, as the core member, a multi-layered laminate of three-dimensional structure nanowebs made of nanofibers that are obtained by electrospinning a polymer material with a low thermal conductivity on one or both surfaces of a nonwoven fabric, and a method of manufacturing the insulator core.

It is a further object of the present invention to provide an insulator core in which a core member with a low thermal conductivity can be produced at a low cost, and a method of manufacturing the insulator core.

### Technical Solution

To accomplish the above and other objects of the present invention, according to an aspect of the present invention, there is provided an insulator core formed of porous nanowebs which are made of a polymer with a low thermal conductivity and integrated by nanofibers having a diameter of less than 3 μm to be spun, thus having a three-dimensional fine-pore structure.

In accordance with another aspect of the present invention, there is also provided an insulator in which a core is encapsulated inside a shell, wherein the core is made of porous nanowebs which are made of a polymer with a low thermal conductivity and integrated by nanofibers having a diameter of less than 3 μm to be spun, thus having a three-dimensional fine-pore structure.

In accordance with still another aspect of the present invention, there is also provided a method of manufacturing an insulator core, the method comprising the steps of: dissolving a polymer with a low thermal conductivity in a solvent to thus form a spinning solution; forming porous nanowebs made of nanofibers and having a three-dimensional fine-pore structure by spinning the spinning solution; and laminating a plurality of layers of the porous nanowebs to thereby form the core.

In accordance with yet another aspect of the present invention, there is also provided an insulator in which a core and a getter member are encapsulated inside a shell member, wherein the core is made of porous nanowebs which are made of a polymer with a low thermal conductivity and integrated by nanofibers having a diameter of less than 3 μm to be spun, thus having a three-dimensional fine-pore structure, and the inside of the shell member is formed in the state of a vacuum or a reduced pressure.

### Advantageous Effects

As described above, the present invention provides a slim type insulator provided with a plurality of fine pores of a three-dimensional structure capable of trapping air by using, as a core member, a multi-layered laminate of nanowebs made of nanofibers that are obtained by electrospinning a polymer material with a low thermal conductivity, and has excellent heat insulating performance even with a thin film.

In addition, the present invention provides an insulator core provided with a plurality of fine pores of a three-dimensional structure capable of trapping air by using, as a core member, a multi-layered laminate of nanowebs, in which air trapped in fine pores has a low thermal conductivity and does not exit by itself as well, to thereby cause convection of the air to be difficult, to thus exhibit excellent heat insulation performance even if the inside of a shell is not in a vacuum atmosphere, and have many benefits in the case of applying the insulator core as an insulator for construction.

In addition, the present invention an insulator core which maximizes excellent heat insulating performance by using, as a core member, a multi-layered laminate of three-dimensional structure porous nanowebs made of nanofibers that are obtained by electrospinning at least one polymer material with a low thermal conductivity, or a polymer material with a low thermal conductivity and an excellent heat resistance alone, or a mixture polymer that is obtained by mixing a polymer with a low thermal conductivity and a polymer with an excellent heat resistance at a predetermined mixture ratio, and a method of manufacturing the insulator core.

Further, since the core member has a heat resistance as described above, when the core member is used in a high temperature environment such as a refrigerator insulator or used for insulation panels in construction, it is possible to suppress occurrence of a fire due to a high melting point.

Furthermore, the present invention can improve the tensile strength of the insulator core required when laminating a core member, to thereby improve productivity of the insulator core, by using, as the core member, a multi-layered laminate of three-dimensional structure nanowebs made of nanofibers that are obtained by electrospinning a polymer material with a low thermal conductivity on one or both surfaces of a nonwoven fabric.

In addition, according to the present invention, a core member is manufactured in a manner that porous nanowebs are formed by spinning a mixture polymer spinning solution on a strip-like transfer sheet, and then are laminated with a nonwoven fabric, to thereby improve the tensile strength of the core member required when laminating the core member in a mass-production process, to thereby improve productivity of the core member.

### DESCRIPTION OF DRAWINGS

FIG. 1 is a cross-sectional view showing an insulator according to the present invention.

FIGS. 2 to 4 are cross-sectional views showing a core member used in a core for an insulator according to first to third embodiments of the present invention.

FIG. 5 is a cross-sectional view of a structure of a shell member used in the present invention.

FIGS. 6A and 6B are flowchart views showing a process of manufacturing a core member used in a core of an insulator according to the present invention, respectively.

FIG. 7 is a schematic sectional view showing an electrospinning apparatus to form nanowebs used as a core member by using a single spinning solution according to the present invention.

FIGS. 8 and 9 are schematic cross-sectional views showing an electrospinning apparatus to form nanowebs used as a core member on both sides of a nonwoven fabric that is a porous substrate according to the present invention, respectively.

FIG. 10 is a schematic cross-sectional view showing an electrospinning apparatus to form nanowebs used as a core member by using two kinds of spinning solutions according to the present invention.

FIG. 11 is a close-up photograph of nanowebs used as a core member according to the present invention.

FIG. 12 shows photographs showing results of heat resistance tests depending upon a content of inorganic materials when nanowebs used as a core member contain the inorganic materials according to the present invention.

### BEST MODE

The foregoing objects, features and advantages will become further obvious through the following detailed description which will be described in detail with reference to the attached drawings, whereby one who has an ordinary skill in the art will readily carry out the invention.

In addition, a detailed description of the present invention will be omitted if it is determined that a specific description of the known art to which the present invention belongs may unnecessarily obscure the subject matter of the present invention.

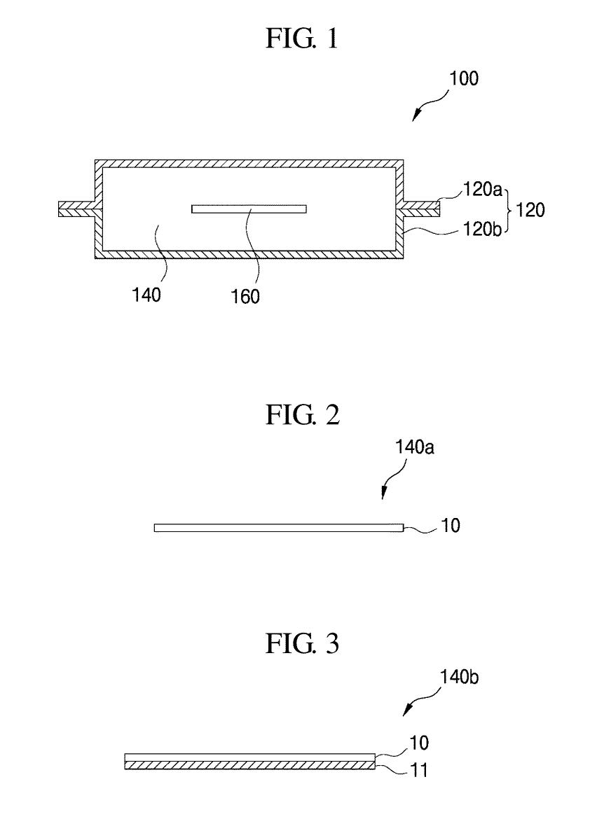

FIG. 1 is a cross-sectional view showing an insulator according to an embodiment of the present invention. FIGS. 2 to 4 are cross-sectional views showing a core member used in a core for an insulator according to first to third embodiments of the present invention.

Referring to FIG. 1, an insulator 100 according to an embodiment of the present invention, includes: a shell member 120 with gas barrier performance and preferably forming a reduced pressure space therein; and a core 140 that is arranged inside the shell member 120, for supporting the shell member 120.

Referring to FIGS. 1 to 4, according to various embodiments of the present invention, the core 140 of FIG. 1 is provided with a plurality of fine pores capable of trapping air by using a core member 140a, 140b or 140c that are formed by laminating a plurality of layers of porous nanowebs 10. Accordingly, since the voluntary escape of the air trapped in the fine pores is difficult, the insulator 100 exhibits excellent heat insulating performance even if the inside of the shell member 120 is not in a vacuum state or in a reduced pressure space. Thus, many benefits may be obtained in the case of applying the core as an insulator for construction.

Here, the reduced pressure space means a space whose internal pressure is reduced so as to be lower than the atmospheric pressure.

In addition, when the inside of the shell member 120 is in a vacuum state or in a reduced pressure space in the insulator 100 according to one embodiment of the present invention, a getter member 160 that adsorbs moisture and gas in the core 140 may be included in the shell member 120 or the core 140. The getter member 160 includes, for example, an absorbent and a gas adsorbent in the form of a powder, and may be packed with a PP (polypropylene) or PE (polyethylene) nonwoven fabric.

In addition, the getter member 160 may include at least one selected from the group consisting of silica gel, zeolite, activated carbon, zirconium, a barium compound, a lithium compound, a magnesium compound, a calcium compound and calcium oxide.

The getter member 160 which can be used in the embodiment of the present invention is not particularly limited, but may adopt materials that are conventionally used in the field of manufacturing vacuum insulators.

The shell member 120 surrounds the core 140, and serves to keep the inside of the shell member 120 to be in a reduced pressure or vacuum state. The shell member 120 is made in the form of an envelope, and sealed by thermally compressing an inlet portion of the shell member 120 under the vacuum environment after inserting the core 140 into the shell member 120. Accordingly, the shell member 120 is fabricated and used in a bag type by sealing the outer portions of three sides of an upper shell 120a and a lower shell 120b, which form a rectangular box shape.

The shell member to be used in the embodiment of the present invention is not particularly limited, but may adopt materials that are conventionally used in the field of manufacturing vacuum insulators. The shell member 120 (denoted as a reference numeral 120a or 120b) that is used in the embodiment of the present invention may include, for example, as shown in FIG. 5, a sealing layer 121 surrounding the core 140; a barrier layer 122 surrounding the sealing layer 121; and a nonwoven fabric layer or a protective layer 123 surrounding the barrier layer 122.

The sealing layer 121 used in the embodiment of the present invention surrounds the built-in core 140 and is adhered to the core 140 to thus make it possible to keep a panel form, when a sealing (compression) is achieved by a thermo-compression method. The sealing layer to be used in the embodiment of the present invention is not particularly limited, but may employ a film material that can be bonded by the thermo-compression method. For example, the sealing layer that is formed of a thermo-compression bonding layer bonded by the thermo-compression method may include: polyolefin-based resins such as linear low density polyethylene (LLDPE), low density polyethylene (LDPE), very low density polyethylene (VLDPE), and high density polyethylene (HDPE); resins that enable thermo-compression bonding, for example, a polypropylene (PP) film, polyacrylonitrile film, polyethylene terephthalate film, or ethylene-vinyl alcohol copolymer film, etc., other than the polyolefin-based resins, or a mixture thereof.

The barrier layer 122 used in the embodiment of the present invention can serve to surround the sealing layer, maintain the degree of vacuum inside, and block the gas and water vapor from the outside. The barrier layer used in the embodiment of the present invention is not particularly limited, and may employ a laminating film (or a deposition film layer) that is obtained by depositing a metal on a metal foil or a resin film, and the like. The metal to be used in the embodiment of the present invention may include aluminum, copper, stainless steel or iron, but is not limited thereto.

In addition, the deposition film may be formed by depositing a metal such as aluminum, stainless steel, cobalt or nickel, silica, alumina or carbon or the like by a vapor deposition method or a sputtering method. A general resin film used in the art can be used as the resin film that is used as a base material. In some embodiments of the present invention, it is preferable to use an aluminum deposition film or aluminum foil as the barrier layer.

The nonwoven fabric layer 123 serves to surround the barrier layer 122, and play a role of a protective layer that protects the vacuum insulator primarily from external impact. In addition, the nonwoven fabric layer can solve the problem that the thermal performance of the insulator decreases due to higher thermal conductivity of the barrier layer. The material of the nonwoven fabric layer may include PP or PTFE (polytetrafluoroethylene).

In addition, a protective layer made of one or two layers to protect the barrier layer 122 can be used in place of the nonwoven fabric layer 123. The protective layer may be formed of one or more resins selected from the group consisting of polyamide, polypropylene, polyethylene terephthalate, polyacrylonitrile, polyvinyl alcohol, nylon, PET (polyethylene terephthalate), K-PET, and ethylene vinyl alcohol.

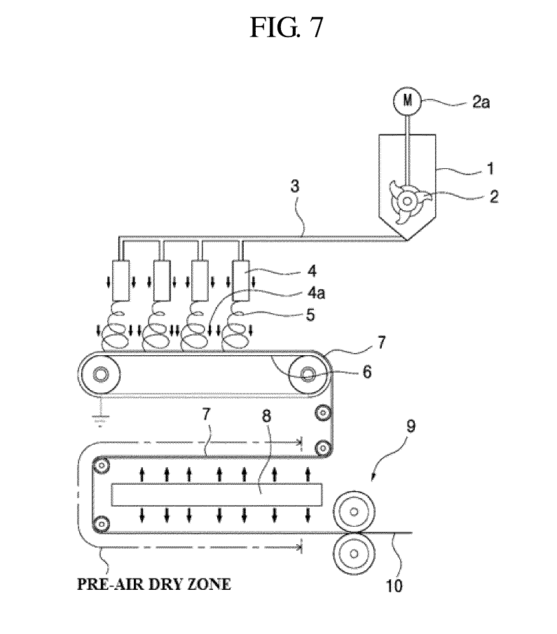

The core member 140a used as the core 140 in the embodiment of the present invention is configured by preparing a spinning solution that is obtained by dissolving a polymer material with a low thermal conductivity in a solvent, and laminating or bending a plurality of layers of sheet-like nanowebs 10 made of nanofibers 5 that are obtained by electrospinning the spinning solution (see FIGS. 2 and 7), so as to be used as the core member with a desired predetermined thickness.

The nanofibers 5 are, for example, made of a diameter of less than 3 μm, and the nanowebs 10 made of the nanofibers 5 include a plurality of fine pores of a three-dimensional structure so that air can be trapped in the fine pores. The nanofibers 5 that form the nanowebs 10 act as heat conduction media so the smaller diameters of the nanofibers 5 are preferable.

The fine pores formed in the nanowebs are set to 100 nm to 3 μm in diameter, preferably, are set to from 600 nm to 800 nm. The diameters of the nanofibers 5 can be by adjusted.

In addition, it is preferable the nanowebs 10 used as an insulator core or an insulating sheet should have a porosity of 70-80%.

As described above, the voluntary escape of air trapped in the fine pores is difficult, that is, convection of the air is suppressed. Thus, the transferred heat is captured in the air trapped in the fine pores, to thus serve to suppress the heat transfer. In this case, since the air trapped in the fine pores is known to have a low thermal conductivity of 0.025 W/mK, the porous nanowebs having a three-dimensional microporous structure with which air can be trapped have excellent heat insulating effects in the Z direction that is perpendicular to the plane of the insulation sheet.

In addition, the core member used as the core 140 in the embodiment of the present invention is configured by laminating a plurality of layers of nanowebs 10 made of nanofibers that are obtained by electrospinning a mixture polymer that is obtained by mixing two or more polymer materials with a low thermal conductivity.

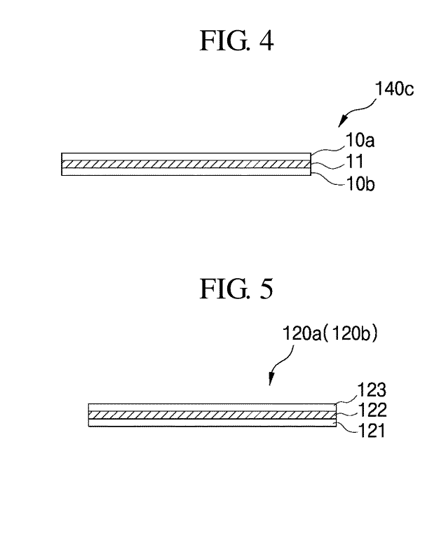

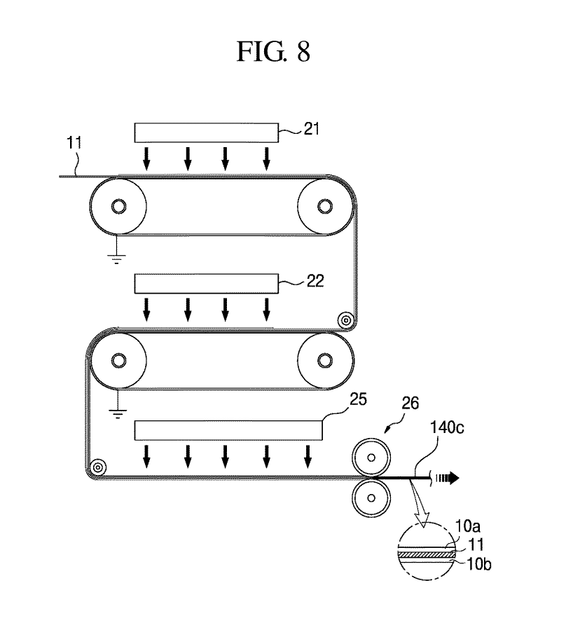

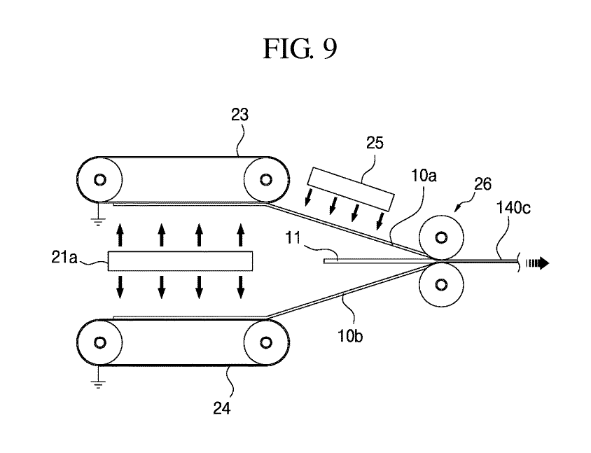

Further, the core member 140b or 140c used as the core 140 in the embodiment of the present invention, may employ, as shown in FIGS. 3 and 4, a laminate of a two-layer or three-layer structure that is obtained by electrospinning a polymer material with a low thermal conductivity on one or both surfaces of a porous substrate 11 such as a nonwoven fabric (see FIGS. 8 and 9).

That is, as shown in FIGS. 3 and 4, the core member 140b or 140c forms a multi-layer structure by forming a nanoweb 10 on one surface of the porous substrate 11 or forming a pair of nanowebs 10a and 10b on both sides of the porous base 11. The porous substrate 11 can improve productivity in the production process of laminating a plurality of layers of the core members 140b and 140c because of its high tensile strength.

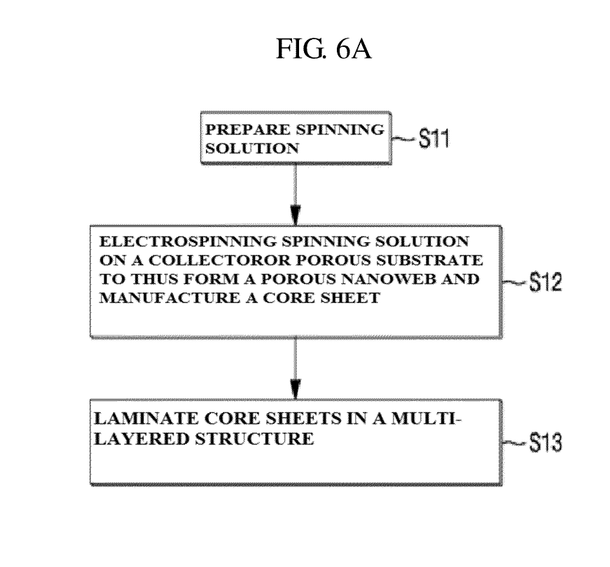

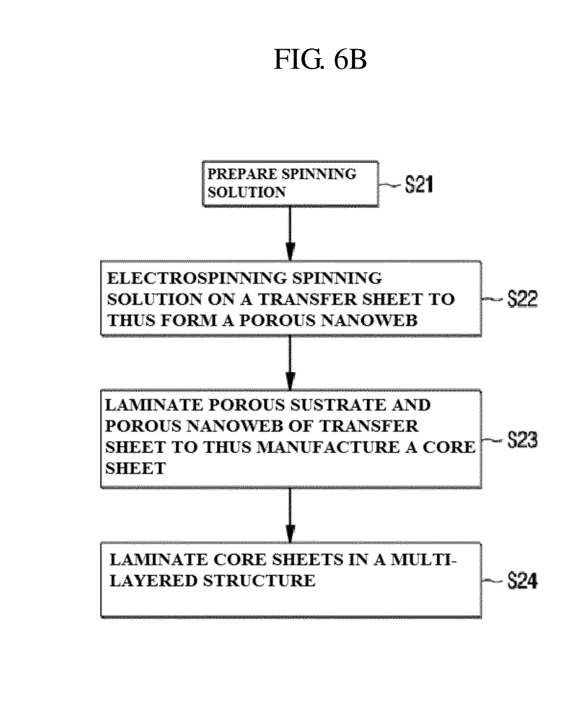

In some embodiments of the present invention, as shown in FIG. 6B, the core member can be produced in such a way that a porous nanoweb is formed by spinning a polymer spinning solution on a strip-like transfer sheet, and then the porous nanoweb and a porous substrate (or a nonwoven fabric) are laminated while separating the transfer sheet from the porous nanoweb.

In this case, in the case of preparation of the porous nanoweb, a production process of the porous nanoweb can proceed without a limit on the tensile strength, and the lamination process of the porous nanoweb with the porous substrate, may also proceed at a high speed without being limited to the tensile strength of the porous substrate.

As a result, in some embodiments of the present invention, it is possible to increase the tensile strength required to produce and laminate the core member in the mass-production process to thereby improve productivity.

In addition, for the purpose of improving heat resistance performance, in some embodiments of the present invention nanowebs that are obtained by electrospinning a polymer material with a low thermal conductivity and an excellent heat resistance alone, or a mixture polymer that is obtained by mixing a polymer with a low thermal conductivity and a polymer with an excellent heat resistance at a predetermined mixture ratio, can be used as a core member.

The spinning method of forming nanowebs that can be used in some embodiments of the present invention can employ any one selected from general electrospinning, air-electrospinning (AES), electrospray, electrobrown spinning, centrifugal electrospinning, and flash-electrosp inning

Further, it is preferable to use an air-electrospinning (AES) method in which air injection is made in respective air spinning nozzles by using a multi-hole spinning pack where, for example, a plurality of spinning nozzles are arranged in a traveling direction of a collector and in a direction perpendicular to the collector, as the spinning solution.

It is preferable that polymers that can be used in some embodiments of the present invention should be dissolved in an organic solvent and spun and should have low thermal conductivity and it is more preferable that polymers should also have excellent heat resistance performance.

The polymer that can be spun and has a low thermal conductivity may include, for example, polyurethane (PU), polystyrene, polyvinyl chloride, cellulose acetate, polyvinylidene fluoride (PVDF), polyacrylonitrile (PAN), polymethyl methacrylate, polyvinyl acetate, polyvinyl alcohol, polyimide, or the like.

Further, the polymer having excellent heat resistance performance is a resin that can be dissolved in an organic solvent for electrospinning and whose melting point is 180° C. or higher, and may employ, for example, any one selected from the group consisting of: aromatic polyester containing at least one of polyacrylonitrile PAN, polyamide, polyimide, polyamide-imide, poly meta-phenylene iso-phthalamide, polysulfone, polyether ketone, polyethylene terephthalate, polytrimethylene terephthalate, and polyethylene naphthalate; polyphosphazenes containing at least one of polytetrafluoroethylene, polydiphenoxy phosphazene, and poly {bis[2-2-methoxyethoxy phosphazene]}; polyurethane copolymer containing at least one of polyurethane and polyether urethane; cellulose acetate, cellulose acetate butylrate, and cellulose acetate propionate.

Furthermore, polyvinylidene fluoride (PVDF) can be used as a polymer that acts as an adhesive layer so that mutual bonding can be easily performed when laminating a plurality of layers of core members made of a laminate of at least one of nanowebs 10, 10a and 10b and a porous substrate 11, as needed, in some embodiments of the present invention.

The thermal conductivity of the polymer is preferably set to less than 0.1 W/mK .

The thermal conductivity of the polyurethane (PU) of the aforementioned polymers is known to be 0.016˜0.040 W/mK, and the thermal conductivities of polystyrene and polyvinyl chloride thereof are known to be 0.033˜0.040 W/mK. Thus, the thermal conductivities of the nanowebs which are obtained by spinning the polyurethane (PU), polystyrene and polyvinyl chloride are also low.

In addition, the nanowebs 10 used as the core members 140a-140c according to some embodiments of the present invention, for example, can be prepared in an ultra-thin film of 30 μm, the nonwoven fabric used as the porous substrate 11 can be also prepared in the thickness of 50 μm. The thickness of the porous nanoweb 5 may be set to be 5 to 50 μm, preferably 30 μm.

Thus, in the case of laminating thirty (30) to forty (40) layers of the core members 140b or 140c on one or both sides of the porous substrate 11, the core 140 having a thickness of 1200 to 4400 μm can be manufactured. That is, the core 140 according to some embodiments of the present invention may have high thermal insulation performance while being made of a very thin film structure.

Furthermore, according to some embodiments of the present invention, as it will be described later, when an electrospinning apparatus uses a multi-hole spinning pack having a large area in which a plurality of spinning nozzles are arranged in a matrix structure, core members of a large area can be obtained with high productivity and can have a sufficiently competitive price.

Further, the nonwoven fabric that can be used as the porous substrate 11 can be employed as the core member of a multi-layer structure having the mechanical tensile strength and the transverse tensile strength and an acceptable range of porosity required when performing the production and lamination processes without limitation.

For example, the available nonwoven fabric is a polyolefin-based porous membrane of a commercially available two-layer or three-layer structure, e.g., a PP/PE or PP/PE/PP membrane or a PP or PE membrane of a single-layer structure, a nonwoven fabric made of PP/PE fibers with a dual structure in which PE is coated on the outer periphery of a PP fiber as a core, or a PET nonwoven fabric made of PET fibers.

Meanwhile, the nanowebs 10 used as the core members 140a-140c according to some embodiments of the present invention can contain a predetermined content of inorganic particles to improve the heat resistance performance as needed. It is preferable that a content of the inorganic particles contained in the nanoweb should be in a range of 10 to 25 wt % for the whole mixture, and a size of each of the inorganic particles should be set between 10˜100 nm.

The inorganic particles may include at least one selected from the group consisting of Al₂O₃, TiO₂, BaTiO₃, Li₂O, LiF, LiOH, Li₃N, BaO, Na₂O, Li₂CO₃, CaCO₃, LiAlO₂, SiO₂, SiO, SnO, SnO₂, PbO₂, ZnO, P₂O₅, CuO, MoO, V₂O₅, B₂O₃, Si₃N₄, CeO₂, Mn₃O₄, Sn₂P₂O₇, Sn₂B₂O₅, and Sn₂BPO₆, and a mixture thereof.

When mixing a spinning solution prepared to spin nanofibers with inorganic particles and then spinning the mixture of the spinning solution and the inorganic particles, the spinning is performed in a state where the mixture of the spinning solution and the inorganic particles is penetrated into the inside of the spun nanofibers or part of the mixture thereof is exposed to the outside. Accordingly, even if the temperatures of the nanowebs containing the inorganic particles are raised to 400˜500° C., since the nanowebs are webs made of nanofibers, the thermal diffusion phenomenon can be suppressed, and the excellent thermal stability is exhibited due to the heat-resistant polymer and the inorganic material contained in the nanofibers.

Hereinbelow, a method of forming nanowebs made of nanofibers by using an air-spray electrospinning apparatus as shown in FIG. 7, according to an embodiment of the present invention will be described in detail.

In the case of an air-electrospinning (AES) method according to the embodiment of the present invention, a high voltage electrostatic force of 90˜120 Kv is applied between the spinning nozzles 4 from which a polymer spinning solution having a sufficient viscosity is spun and the collector 6, and thus ultra-fine nanofibers 5 are spun on the collector 6, to thus form nanowebs 7, in which case air 4a is sprayed for each spinning nozzle 4 to thus prevent the spun nanofibers 5 from flying without being collected on the collector 6.

The air-electrospinning apparatus shown in FIG. 7 includes: a mixing tank 1 having an agitator 2 that uses a mixing motor 2a using a pneumatic pressure as a driving source, so as to prevent phase separation until a polymer material with a low thermal conductivity, or a heat-resistant polymer material is mixed with inorganic particles in a solvent, and then the mixture is spun; and a number of spin nozzles 4 that are connected with a high-voltage generator (not shown). A polymer spinning solution that is discharged through a number of the spin nozzles 4 that are connected with the mixing tank 1 via a fixed quantity pump (not shown) and a transfer tube 3 passes through the spin nozzles 4 that are electrically charged by the high-voltage generator to then be discharged as the nanofibers 5. Thus, the nanofibers 5 are accumulated on the collector 6 that is wounded and is configured in a conveyor belt form that moves at a constant speed, to thereby farm porous nanowebs 7.

In general, when a multi-hole spin pack (e.g., 245 mm/61 holes) is applied for mass-production, mutual interference between the multi-holes takes place to thus cause fibers to fly to thereby prevent the fibers from being captured. As a result, since a separator (or separation membrane obtained by using the multi-hole spin pack becomes too bulky, it is difficult to form the separator, to thus act to cause a spinning trouble.

In consideration of this, as shown in FIG. 7 in the embodiment of the present invention, the porous nanowebs 7 are produced by using the air-electrospinning method in which air 4a is sprayed for each spinning nozzle 4 by using the multi-hole spin pack.

That is, in the embodiment of the present invention, when electrospinning is achieved by using the air-electrospinning method, air is injected from the outer periphery of each of the spin nozzles 4, to thus make the air play a dominant role of capturing and integrating the fibers made of the fast volatile polymer, and to thereby produce nanowebs having high rigidity and minimize a spinning trouble that can be caused from the fly of the fibers.

In the embodiment of the present invention, in order to mix a polymer material with a low thermal conductivity and a heat-resistant polymer material to then spin the mixed polymer material, it is preferable to produce a mixture spinning solution by adding the mixed polymer material to a two-component solvent.

The obtained porous nanowebs 7 is calendered at a temperature of the melting point of the polymer or below in a calender device 9, to thus obtain nanowebs 10 of thin films used as a core member.

In the embodiment of the present invention, the porous nanowebs 7 obtained as above as needed are able to undergo a calendaring process after undergoing a process of adjusting the amount of the solvent and moisture remaining on the surfaces of the nanowebs 7, while passing through a pre-air dry zone by a pre-heater 8.

In the pre-air dry zone by the pre-heater 8, air of 20˜40° C. is applied to webs by using a fan, and thus the amount of the solvent and moisture remaining on the surfaces of the nanowebs 7 is adjusted, to thereby prevent the nanowebs from being bulky and to thus play a role of enhancing the strength of the separator and simultaneously adjust porosity of the separator.

In this case, in the case that calendering is performed at a state the solvent volatilization is too much caused, the porosity is increased but the strength of the nanowebs is weak. Reversely, when the solvent volatilization is little caused, a phenomenon of melting the nanowebs occurs.

As shown in FIG. 6A, according to the method of forming porous nanowebs 10 by using the above-described electrospinning apparatus of FIG. 7, a polymer material with a low thermal conductivity alone, or a mixture polymer that is obtained by mixing a polymer with a low thermal conductivity and a polymer with an excellent heat resistance is dissolved in a solvent to thus prepare a spinning solution (S11). In this case, a predetermined amount of inorganic particles can be added in the spinning solution as needed to enhance the heat resistance performance. Further, when nanowebs are formed by using a polymer material with a low thermal conductivity and an excellent heat resistance, for example, polyurethane (PU), the nanowebs have both a heat insulating property and a heat resistance property preferably

Then, the spinning solution is directly spun on the collector 6, or on the porous substrate 11 such as a nonwoven fabric by using the electrospinning apparatus, to thus produce porous nanowebs 10 of a single-layer structure or core sheets of a multi-layer structure made of the porous nanowebs 10 and the porous substrate 11, that is, core members 140a, 140b and 140c (S12).

Subsequently, when the obtained core sheets are wide, the core sheets are cut to a desired width and then are folded a number of times in a plate-like form so as to have a desired thickness or are wound in a plate-like form by a winding machine, or a plurality of the core sheets are cut to have a desired shape and then are laminated in multiple layers to thus form the core 140 (S13).

Further, after laminating a plurality of the core members 140a-140c, it is also possible to cut the laminate to a desired shape to form the core 140.

In the embodiments of the present invention, the method of forming the core 140 having a desired shape and thickness by using a plurality of the core members 140a-140c is not limited to the above embodiments, but can be varied in various ways.

In this case, a plurality of core sheets laminated as needed, i.e. the core members 140a-140c are hot or cold compressed preferably to increase a laminating density.

In some embodiments of the present invention, after the fabrication of the core sheets each having a large area, the core sheets may be cut and used in a specified shape depending on an intended use such as insulators for the construction or refrigerators.

In some embodiments of the present invention, as shown in FIG. 6B, a spinning solution obtained in a spinning solution preparation step (S21) is spun on a transfer sheet made of one of paper, a nonwoven fabric made of a polymer material that is not dissolved in a solvent contained in the spinning solution, and a polyolefin-based film, to thus form porous nanowebs (S22), then the transfer sheet is removed, after laminating the nanowebs with the nonwoven fabric or the nanowebs are laminated with the nonwoven fabric while separating the nanowebs from the transfer sheet, to thus produce core sheets (S23), and then the resulting core sheets are laminated in a multi-layer stage to thus form a core 140 (S24).

It is possible to improve productivity in mass-production of producing the nanowebs by using the above transfer sheet.

A method of forming a nanoweb used as a core member on both surfaces of a nonwoven fabric used as a porous substrate according to an embodiment of the present invention will now be described with reference to an electrospinning apparatus shown in FIG. 8.

First, while feeding the porous substrate 11 to the top of a collector 23, a first nanoweb 10a is formed on one surface of the porous substrate 11 by using a first electrospinning apparatus 21, then a second nanoweb 10b is formed on the other surface of the porous substrate 11 using a second electrospinning apparatus 22 in a state of reversing the porous substrate 11 on which the first nanoweb 10a has been formed, a pre-air dry process advances by a pre-heater 25 to thus adjust the amount of the solvent and water remaining on the surfaces of the nanowebs 10a and 10b, and nanowebs are calendered at a temperature of the melting point of the polymer or below in a calender device 26, to thus obtain nanowebs 10a and 10b of a multi-layer structure used as a core member 140c.

A method of forming a nanoweb used as a core member on both surfaces of a nonwoven fabric used as a porous substrate according to an embodiment of the present invention will now be described with reference to an electrospinning apparatus shown in FIG. 9.

The electrospinning apparatus of FIG. 9 is implemented by using a two-way electrospinning apparatus 21a that can enable the electrospinning to the top and bottom of the porous substrate.

In this case, the first nanoweb 10a and the second nanoweb 10b are formed on the transfer sheet, and then it is also possible to remove the transfer sheet when the first nanoweb 10a and the second nanoweb 10b are laminated with the porous substrate 11.

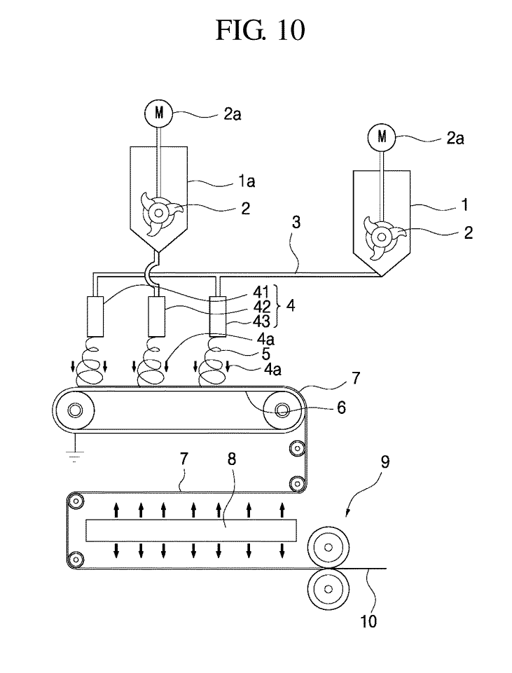

The case where the mixed polymer spinning solution is stored in the mixing tank 1 and is spun via the plurality of the nozzles 4, has been described in the above-described embodiments. However, as shown in FIG. 10, respectively different polymer spinning solutions are stored in at least two mixing tanks 1 and la and then the respectively different polymer spinning solutions are spun in a crosslink way via respectively different spin nozzles 41 and 43 for the mixing tank 1 and a spin nozzle 42 for the mixing tank 1a, to thereby form a nanoweb 7.

For example, when a first spinning solution that is prepared by dissolving a polymer material with a low thermal conductivity in a solvent is stored in the first mixing tank 1 and a second spinning solution that is prepared by dissolving a heat-resistant polymer material in a solvent is stored in the second mixing tank 1a, and then the first and second spinning solutions are spun, the nanoweb made with a low thermal conductivity is laminated on the top and bottom of the nanoweb made of the heat-resistant polymer material, respectively. Then, when a calendering process is undergone, a core member of a multi-layered structure can be obtained.

Further, when a first spinning solution that is prepared by dissolving a polymer material with a low thermal conductivity and a heat resistance in a solvent is stored in the first mixing tank 1 and a second spinning solution that is prepared by dissolving a polymer material with a high adhesiveness in a solvent is stored in the second mixing tank 1a, and then the first and second spinning solutions are spun in a crosslink way, to thus form a laminate of a multi-layered structure.

According to a method of assembling an insulator, the core 140 that is obtained by laminating a plurality of layers of the core members is first inserted into the inside the shell member 120 with an open side. In this case, when constituting the vacuum insulator, it is preferable that a getter member 160 should be inserted with the core 140 into the inside the shell member.

Then, in the case of the vacuum insulator, an open part of the shell member 120 is sealed by a thermo-compression method in a vacuum environment. However, in the case of a non-vacuum insulator, an open part of the shell member 120 is sealed by a thermo-compression method in an atmospheric environment.

As described above, a slim type insulator using an insulator core is provided, which includes a plurality of fine pores of a three-dimensional structure capable of trapping air by using, as a core member, a multi-layered laminate of nanowebs made of nanofibers that are obtained by electrospinning a polymer material with a low thermal conductivity, and has excellent heat insulating performance even with a thin film.

Hereinafter, the present invention will be described in more detail with reference to the following examples. However, the following embodiments are nothing but the illustration of the invention only, and do not limit the scope of the invention.

### EXAMPLE 1

PAN/PVDF (6/4) 11 wt % Web DMAc Solution

In order to manufacture a nanoweb made of nanofibers with a low thermal conductivity, a heat resistance, and an excellent adhesive strength by an air-electrospinning (AES) method, polyacrylonitrile (PAN) of 6.6 g and polyvinylidene fluoride (PVDF) of 4.4 g were added to dimethylacetamide (DMAc) of 89 g as a solvent, and stirred at 80° C., to thus have prepared a mixture spinning solution made of a mixture polymer.

The spinning solution consists of different phases from each other with respect to the mixture polymer. Accordingly, phase separation can occur rapidly. The spinning solution was put into a mixing tank so as to be stirred using a pneumatic motor to then discharge the polymer solution by 17.5 ul/min/hole. Here, temperature of the spinning section was maintained at 33° C. and humidity thereof was maintained to 60%, while applying a voltage of 100 KV to a spin nozzle pack using a high voltage generator and at the same time an air pressure of 0.25 MPa to the spin nozzle pack, to thus have manufactured a porous nanoweb made of ultrafine nanofibers with a mixture of PAN and PVDF.

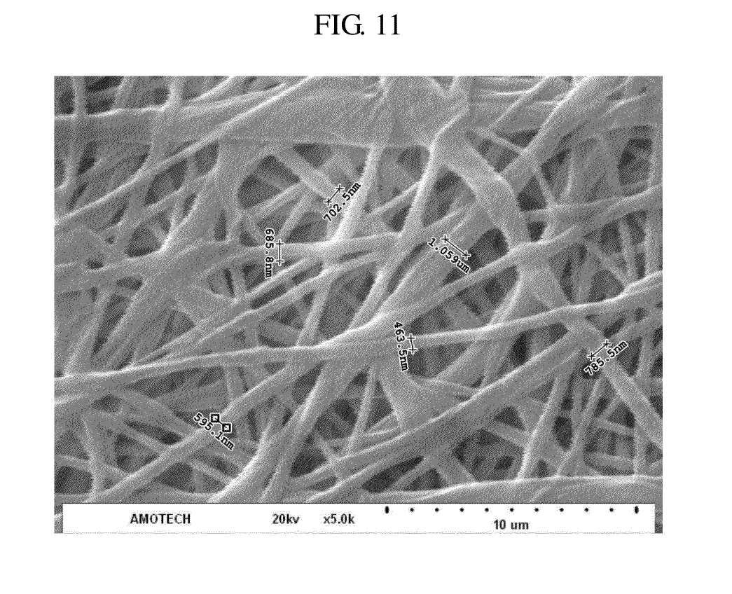

Subsequently, the porous nanoweb was moved to a calendering apparatus, to thus have performed a calendering process by using heating/pressurizing rolls. Then, in order to remove the solvent and moisture that may remain, the porous nanoweb was made to pass through a hot-air dryer at a temperature of 100° C. and with a speed of 20 m/sec, to thus have obtained a nanoweb of a single layer structure. An enlarged image of the obtained nanoweb was photographed by Scanning Electron Microscopy (SEM) and shown in FIG. 11.

<Heat Resistance Test According to Content of Inorganic Particles>

### EXAMPLES 2 TO 4, COMPARATIVE EXAMPLES 1, 2 AND 3>

In order to manufacture a nanoweb by an air-electrospinning (AES) method, polyacrylonitrile (PAN) of 6.6 g and polyvinylidene fluoride (PVDF) of 4.4 g were added to dimethylacetamide (DMAc) of 89 g as a solvent, and stirred at 80° C., to thus have prepared a mixture spinning solution made of a mixture polymer. Subsequently, inorganic particles of 20 nm such as Al₂O₃ were added in the prepared spinning solution by 20 wt % for the total solid content.

The spinning solution consists of different phases from each other with respect to the mixture polymer. Accordingly, phase separation can occur rapidly. The spinning solution was put into a mixing tank so as to be stirred using a pneumatic motor to then discharge the polymer solution by 17.5 ul/min/hole. Here, temperature of the spinning section was maintained at 33° C. and humidity thereof was maintained to 60%, while applying a voltage of 100 KV to a spin nozzle pack using a high voltage generator and at the same time an air pressure of 0.25 MPa to the spin nozzle pack, to thus have manufactured a porous nanoweb made of ultrafine nanofibers with a mixture of PAN and PVDF mixed with the 20 nm Al₂O₃ inorganic particles.

Subsequently, the obtained porous nanoweb of the single layer structure was moved to a calendering apparatus, to thus have performed a calendering process by using heating/pressurizing rolls. Then, in order to remove the solvent and moisture that may remain, the porous nanoweb was made to pass through a hot-air dryer at a temperature of 100° C. and with a speed of 20 m/sec, to thus have obtained a core member of 20 nm thick of Example 2.

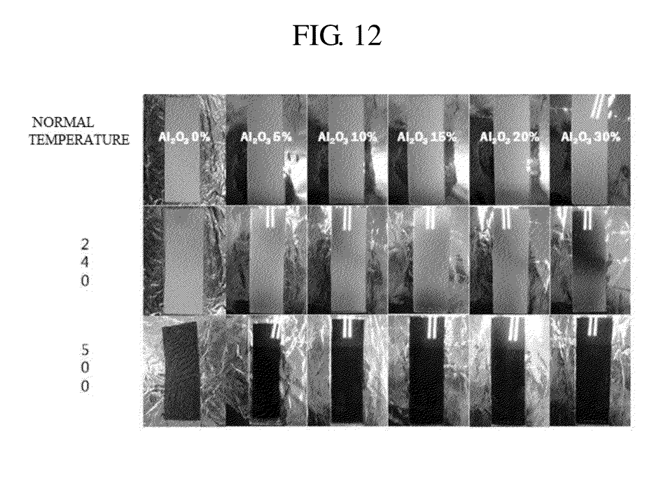

In Comparative Example 1, Comparative Example 2, Examples 2 to 4 and Comparative Example 3, the rest of conditions thereof were identical to those of Example 2, except that the 20 nm Al₂O₃ inorganic particles were added the spinning solution in various mixture ratios such as 0, 5, 10, 15, 30 wt %, based on the total including the PAN and PVDF mixture polymer and the inorganic particles in Example 1, in which the core member of a single-layer structure was prepared identically to Example 2, the obtained core member was undergone heat resistance tests of 240° C. and 500° C., to then have confirmed whether or not the shrinkage takes place. Photographs showing the heat resistance test results are shown in FIG. 12.

In addition, depending upon the heat resistance tests, the shrinkage ratio and tensile strength of the core member, and the spinning stability of the spinning solution, were examined and shown in Table 2.

TABLE 2

| | Shrinkage | | |
|---|---|---|---|
| | ratio (MD | Tensile strength (MD | Spinning |
| | direction) | direction: kgf/cm²) | stability |
| Comparative | 20.68 | 169.27 | Very Good |
| Example 1 (0 wt %) | | | |
| Comparative | 12.59 | 166.21 | Very Good |
| Example 2 (5 wt %) | | | |
| Example 2 (10 wt %) | 5.33 | 110.13 | Good |
| Example 3 (15 wt %) | 2.67 | 91.77 | Good |
| Example 4 (20 wt %) | 2 | 88.71 | Good |
| Comparative | 1 | 67.21 | Unstable |
| Example 3 (30 wt %) | | | |

When the content of the inorganic particles to be added to the spinning solution was varied from 10 to 20 wt %, the shrinkage ratio was low as 2 to 5.33 and the spinning stability was also good when having undergone the heat resistance test of 500° C. Considering the shrinkage ratio and the tensile strength, it was found that core member having the most preferable heat resistance was Example 3 (15 wt %).

As described above, the present invention has been described with respect to particularly preferred embodiments. However, the present invention is not limited to the above embodiments, and it is possible for one who has an ordinary skill in the art to make various modifications and variations, without departing off the spirit of the present invention. Thus, the protective scope of the present invention is not defined within the detailed description thereof but is defined by the claims to be described later and the technical spirit of the present invention.

### INDUSTRIAL APPLICABILITY

The present invention can be applied to manufacturing of core members used for cores of a vacuum or non-vacuum insulators.

1. An insulator core comprising porous nanowebs which are made of a polymer with a low thermal conductivity and integrated by nanofibers having a diameter of less than 3 μm to be spun, thus having a three-dimensional fine-pore structure.

2. The insulator core according to claim 1, further comprising a porous substrate on one or both sides of which the porous nanowebs are formed, and acting as a support role.

3. The insulator core according to claim 2, wherein the porous substrate comprises a nonwoven fabric made of a polyolefin-based resin.

4. The insulator core according to claim 1, wherein the polymer comprises a mixture polymer of a polymer with a low thermal conductivity and a heat-resistant polymer.

5. The insulator core according to claim 1, wherein each of the porous nanowebs comprises a structure of a laminate of a first nanoweb layer made of a polymer with a low thermal conductivity and a second nanoweb layer made of a heat-resistant polymer or a polymer having an excellent adhesiveness.

6. The insulator core according to claim 1, wherein each of the porous nanowebs a structure that is obtained by spinning a first nanoweb layer made of a polymer with a low thermal conductivity and a second nanoweb layer made of a heat-resistant polymer or a polymer having an excellent adhesiveness in a crosslink way.

7. The insulator core according to claim 1, wherein the fine pores of each of the porous nanowebs are set in a range of 100 nm to 3 μm.

8. The insulator core according to claim 7, wherein the fine pores of each of the porous nanowebs are set in a range of 600 nm to 800 nm.

9. The insulator core according to claim 1, wherein the polymer having a low thermal conductivity is at least one selected from the group consisting of polyurethane (PU), polystyrene, polyvinyl chloride, cellulose acetate, polyvinylidene fluoride (PVDF), polyacrylonitrile (PAN), polymethyl methacrylate, polyvinylacetate, polyvinyl alcohol and polyimide.

10. The insulator core according to claim 1, wherein the thermal conductivity of the polymer is set to less than 0.1 W/mK.

11. The insulator core according to claim 1, further comprising the inorganic particles that are spun together with the nanofibers.

12. An insulator comprising a core that is encapsulated inside a shell, wherein the core is made of porous nanowebs which are made of a polymer with a low thermal conductivity and integrated by nanofibers having a diameter of less than 3 μm to be spun, thus having a three-dimensional fine-pore structure.

13. The insulator according to claim 12, wherein the core has a structure of folding the porous nanowebs a number of times in a plate-like form or winding the porous nanowebs in a plate-like form by a winding machine, or cutting a plurality of the porous nanowebs to have a desired shape and then laminating the porous nanowebs in multiple layers.

14. An insulator comprising a core and a getter member that are encapsulated inside a shell member, wherein the core is made of porous nanowebs which are made of a polymer with a low thermal conductivity and integrated by nanofibers having a diameter of less than 3 μm to be spun, thus having a three-dimensional fine-pore structure, and the inside of the shell member is formed in the state of a vacuum or a reduced pressure.

15. A method of manufacturing an insulator core, the method comprising the steps of:
dissolving a polymer with a low thermal conductivity in a solvent to thus form a spinning solution;
forming porous nanowebs made of nanofibers and having a three-dimensional fine-pore structure by spinning the spinning solution; and
laminating a plurality of layers of the porous nanowebs to thereby form the core.

16. The method of claim 15, wherein the step of forming the porous nanowebs comprises the step of spinning the spinning solution on one or both surfaces of a porous substrate playing a support role, to thus form the porous nanowebs.

17. The method of claim 15, further comprising the step of laminating the porous nanowebs on one or both sides of the porous substrate playing a support role, before the step of laminating a plurality of layers of the porous nanowebs thereby forming the core.

18. The method of claim 15, wherein the step of forming the porous nanowebs comprises the step of spinning the spinning solution on a transfer sheet to thus form the porous nanowebs on the transfer sheet, and further comprises the step of laminating the porous nanowebs on one or both sides of the porous substrate playing a support role, to then remove the transfer sheet.
